(19) United States
(12) Patent Application Publication
(10) Pub. No.: US 2026/0339864 A1
(43) Pub. Date: Oct. 29, 2026

(54) SYSTEM AND METHOD FOR DYNAMICALLY ADAPTIVE SYNCHRONIZATION MECHANISM

(71) Applicant: Samsung Electronics Co., Ltd., Suwon-si (KR)

(72) Inventors: Anirban Saha, Bengaluru (IN); Surendra Singh, Bengaluru (IN); Tushar Vrind, Bengaluru (IN)

(21) Appl. No.: 19/426,307

(22) Filed: Dec. 19, 2025

(30) Foreign Application Priority Data
Apr. 24, 2025 (IN) 202541039427
Dec. 11, 2025 (IN) 202541039427

(51) Int. Cl. G06F 13/364

(52) U.S. Cl. CPC G06F 13/364

(57) ABSTRACT

A method for dynamically adaptive synchronization mechanism includes initiating an acquisition of a lock by a lock contender among one or more lock contenders based on contention. The acquiring of the lock indicates exclusive access to a shared resource. The method includes computing at least one of an elapsed time since the lock was acquired and a remaining time until the lock is released in response to detecting that the lock is busy. The busy lock indicates that the lock is acquired by at least one other lock contender from among the one or more lock contenders. The method includes identifying a type of lock contender based on determining whether the lock contender is context-switchable. The type of lock contender corresponds to a predefined set of types. The method further includes transitioning the lock contender to a selected one of a context-switching mode, a busy-spinning mode, and a low-power mode.

### CROSS-REFERENCE TO RELATED APPLICATION(S)

This U.S. non-provisional patent application claims priority under 35 U.S.C. § 119 to Indian Provisional Application No. 202541039427, filed on Apr. 24, 2025 and Indian Patent Application No. 202541039427, filed on Dec. 11, 2025, in the Indian Patent Office, the disclosure of each of which is incorporated herein its entirety by reference.

### BACKGROUND

The present disclosure relates to synchronization mechanisms in embedded and multicore computing environments, and more particularly to a system and a method for dynamically adaptive synchronization mechanism.

As computing architectures have evolved, multicore processors have become the standard for embedded systems, real-time operating systems (RTOS), and general-purpose computing. The multicore environments enable parallel execution of multiple threads and tasks, improving overall performance and responsiveness. However, with increased concurrency, the challenge of efficient synchronization to ensure safe access to shared resources is encountered while minimizing performance degradation due to lock contention.

The lock contention refers to a situation in a multicore computing environment where multiple lock contenders such as threads or processes compete for access to a shared resource that is protected by a lock. When a thread requests a lock that is already held by another thread, the first thread has to wait until the lock is released, leading to delays, reduced performance, and potential bottlenecks. The lock contention occurs frequently in highly parallel applications, where multiple threads try to access the same critical section of code.

Synchronization primitives such as mutexes and spinlocks are commonly used to manage concurrent access to shared resources. A mutex allows only one thread to access a resource at a time, blocking other threads and invoking a context switch if the lock is unavailable. Mutexes are suitable for thread-based synchronization but are not applicable in execution contexts such as Interrupt Service Routines (ISRs), where blocking is infeasible due to real-time constraints.

Conversely, a spinlock operates by continuously checking (spinning) until the lock becomes available. While the spinlock technique avoids the overhead of context switching, the spinlock technique may be inefficient in scenarios where the lock remains unavailable for an extended period, leading to excessive CPU resource consumption. Such inefficiency is particularly problematic in power-sensitive embedded systems and real-time applications where responsiveness and energy conservation are critical. The synchronization techniques such as the mutex and the spinlock techniques are further explained in detail in the following with the help of figures.

FIG. 1 illustrates a method 100 for dynamically adaptive synchronization mechanism, according to an existing art.

In an existing art, a mutex (Mutual Exclusion) is a synchronization mechanism used in multithreading environments to ensure that only one thread may access a shared resource at a time, preventing race conditions and data inconsistency.

According to an existing art, at step 102, the method 100 includes requesting by a mutex Application Program Interface (API) for access to a shared resource.

At step 104, the method 104 includes checking whether the mutex is currently available for resource sharing. If the mutex is available for resource sharing, step 106 is performed. If the mutex is unavailable or the mutex is busy, step 110 is performed.

At step 106, upon detecting that the mutex is available for resource sharing, the method 100 includes acquiring the mutex by the thread. Acquiring the thread indicates an exclusive access to the shared resource.

At step 108, the method 100 includes accessing the shared resource by the thread to perform a predefined operation.

At step 110, upon detecting that the mutex is unavailable for resource sharing, the method 100 includes suspending the mutex and performing a context-switch out. The context-switch out indicates that the current thread is removed from execution and placed into a waiting state.

At step 112, upon release of the mutex, the method 100 includes performing a context-switch in. The context-switch in indicates the process where a previously suspended or waiting thread is resumed and scheduled back onto the CPU for execution. At step 114, the method 100 includes releasing mutex.

FIG. 2 illustrates a method 200 for dynamically adaptive synchronization mechanism, according to another existing art.

According to an embodiment, at step 202, the method 200 includes requesting, by a lock acquire API, for access to a shared resource. At step 204, the method 200 includes checking whether the lock is currently available for resource access.

If the lock is available, step 206 is performed. In another embodiment, if the lock is unavailable or busy, step 210 is performed. At step 206, upon detecting that the lock is available, the method 200 includes successfully acquiring the lock by the thread. The acquiring of the lock grants exclusive access to the shared resource.

At step 208, the method 200 includes accessing the shared resource by the thread to perform a predefined operation. At step 210, upon detecting that the lock is unavailable, the method 200 includes performing busy spinning. Busy spinning involves continuously checking for the lock’s availability in a loop without releasing CPU control, ensuring that the thread remains active until the lock becomes available.

One significant challenge in multicore environments is determining the optimal strategy for handling lock contentions. Conventional approaches adopt only one of the following behaviors and fails to provide an integration:
a. Busy-Spinning: A thread or ISR continuously polls for the lock, which is wasteful if the lock is held for a long duration.
b. Low-Power Mode Transitioning: The core enters a low-power state while waiting for the lock, which can be inefficient if the lock is released before the transition overhead is recovered.
c. Context Switching: The thread relinquishes the CPU and waits to be rescheduled, but this introduces scheduling latency and overhead.

Each of these approaches have trade-offs. If a wait time is short, context switching or entering low-power mode may be unnecessary overhead. If the wait time is long, busy-spinning wastes CPU cycles, degrading performance. This problem is further exacerbated in embedded systems where real-time responsiveness and power efficiency are critical.

Additionally, different execution contexts have distinct synchronization requirements:
a. Thread-to-thread synchronization commonly uses mutexes, but context switching overhead can be costly when the lock is held for a short time.
b. Thread-to-ISR synchronization requires spinlocks, but excessive spinning wastes resources.
c. ISR-to-ISR synchronization also uses spinlocks, but determining when to spin versus entering low-power mode remains a challenge.

Therefore, in view of the above-mentioned problems, it is desirable to provide a system and a method that may eliminate, or at least, mitigate one or more of the above-mentioned problems associated with the existing solutions.

### SUMMARY

This summary is provided to introduce a selection of concepts, in a simplified format, that are further described in the detailed description of the present disclosure. This summary is neither intended to identify key or essential inventive concepts of the present disclosure nor is it intended to determine the scope of the present disclosure.

In an embodiment, a method for dynamically adaptive synchronization includes initiating an acquisition of a lock by a lock contender among one or more lock contenders based on contention. The acquiring of the lock indicates exclusive access to a shared resource. The method further includes computing at least one of an elapsed time since lock acquisition and a remaining time till lock is released in response to detecting that the lock is busy. The busy lock indicates that the lock is acquired by at least one other lock contender from among the one or more lock contenders. The method further includes identifying a type of the lock contender based on identifying whether the lock contender is context-switchable. The type of lock contender corresponds to one of a predefined set of types. The method further includes transitioning the lock contender to a selected one of a context-switching mode, a busy-spinning mode, and a low-power mode. The selection of the mode is based on a plurality of factors comprising a lock contender's capability to transition to each of the modes, a current state of a lock owner indicated by elapsed time, a relative execution cost associated with each of the modes, and a predicted remaining time until the lock becomes available.

In another embodiment, a method for dynamically adaptive synchronization mechanism includes initiating an acquisition of a lock by a lock contender among one or more lock contenders based on contention. The acquiring of the lock indicates exclusive access to a shared resource. The method further includes identifying a type of lock contender of the lock contender based on detecting the lock is busy. The type of lock contender is associated with a plurality of types of lock contenders. The method further includes transitioning the lock contender to at least one of a context-switching mode and a low-power mode based on the identified type of lock contender and comparing an execution cost of each mode against a set blocking threshold.

In another embodiment, a system for dynamically adaptive synchronization mechanism includes a memory and a processor in communication with the memory. The processor is configured to initiate an acquisition of a lock by a lock contender among one or more lock contenders based on contention. The acquiring of the lock indicates exclusive access to a shared resource. The processor is configured to compute at least one of an elapsed time since lock acquisition and a remaining time till lock is released in response to detecting that the lock is busy. The busy lock indicates that the lock is acquired by at least one other lock contender from among the one or more lock contenders. The processor is configured to identify a type of the lock contender based on identifying whether the lock contender is context-switchable. The type of lock contender corresponds to one of a predefined set of types. The processor is configured to transition the lock contender to a selected one of a context-switching mode, a busy-spinning mode, and a low-power mode. The selection of the mode is based on a plurality of factors comprising a lock contender's capability to transition to each of the modes, a current state of a lock owner indicated by elapsed time, a relative execution cost associated with each of the modes, and a predicted remaining time until the lock becomes available.

In another embodiment, a system for dynamically adaptive synchronization mechanism includes a memory and at least one processor in communication with the memory. The at least one processor is configured to initiate an acquisition of a lock by a lock contender among one or more lock contenders based on contention. The acquiring of the lock indicates exclusive access to a shared resource. The at least one processor is configured to identify a type of lock contender of the lock contender based on detecting the lock is busy. The type of lock contender is associated with a plurality of types of lock contenders. The at least one processor is configured to transition the lock contender to at least one of a context-switching mode and a low-power mode based on the identified type of lock contender and comparing the execution cost of each mode against a set blocking threshold.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a method for dynamically adaptive synchronization mechanism, according to an existing art;

FIG. 2 illustrates a method for dynamically adaptive synchronization mechanism, according to another existing art;

FIG. 3 illustrates a system 300 for dynamically adaptive synchronization mechanism, according to an embodiment of the present disclosure

FIGS. 4A and 4B illustrate a method 400 for dynamically adaptive synchronization mechanism, according to an exemplary embodiment of the present disclosure; and

FIG. 5 illustrates a method 500 for dynamically adaptive synchronization mechanism, according to another embodiment of the present disclosure.

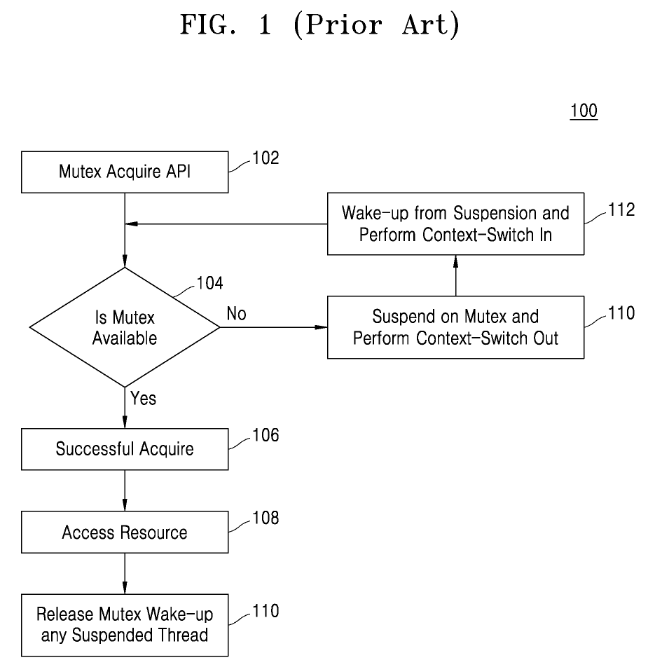

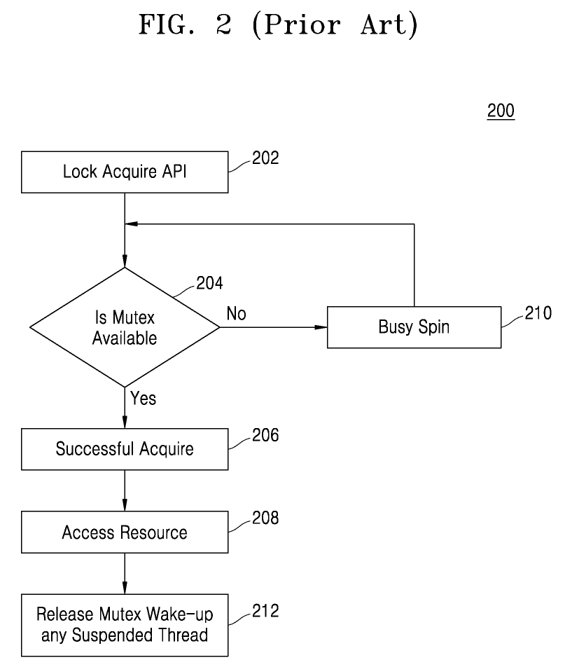

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention.

Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

Embodiments of the present invention will be described below in detail with reference to the accompanying drawings.

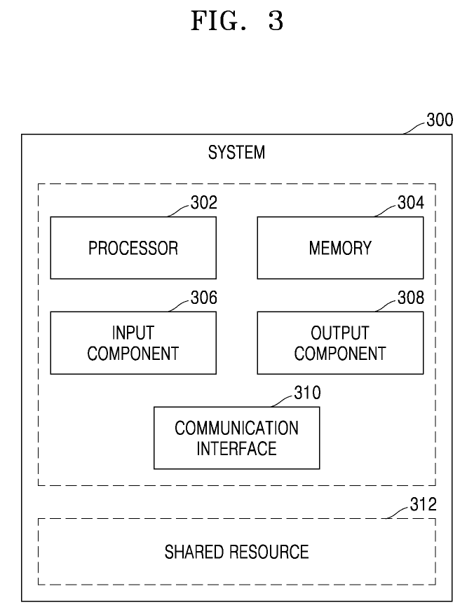

FIG. 3 illustrates a system 300 for dynamically adaptive synchronization mechanism, according to an embodiment of the present disclosure.

The system 300 includes a processor 302, a memory 304, an input component 306, an output component 308, a communication interface 310, and a shared resource 312. The processor 302, the memory 304, the input component 306, the output component 308, and the communication interface 310 may be connected to each other via bus (not shown).

The processor 302, as used herein, means any type of computational circuit that may comprise hardware elements and software elements. The processor 302 may be embodied as a multi-core processor, a single-core processor, or a combination of one or more multi-core processors and/or one or more single-core processors, a distributed processing system 300, or the like. The processor 302 may be a Central Processing Unit (CPU) a graphics processing unit (GPU), an accelerated processing unit (APU), an application-specific integrated circuit (ASIC), or another type of processing component.

In an embodiment of the present disclosure, the processor 302 may be configured to initiate an acquisition of a lock by a lock contender among one or more lock contenders based on contention. The lock acquisition indicates exclusive access to the shared resource 312.

The processor 302 is further configured to compute at least one of an elapsed time since lock acquisition and a remaining time till lock is released in response to detecting that the lock is busy. The busy lock indicates that the lock is acquired by at least one other lock contender from among the one or more lock contenders.

The processor 302 is further configured to identify a type of the lock contender based on identifying whether the lock contender is context-switchable, wherein the type of lock contender corresponds to one of a predefined set of types.

The processor 302 is further configured to transition the lock contender to one of a context-switching mode, a busy-spinning mode, and a low-power mode based on at least one of the elapsed time and the identified type of the lock contender.

In another embodiment of the present disclosure, the processor 302 is configured to initiate an acquisition of a lock by a lock contender among one or more lock contenders based on contention. Acquiring the lock indicates exclusive access to a shared resource.

The processor 302 is further configured to identify a type of the lock contender of the lock contender based on detecting the lock is busy. The type of lock contender is associated with a plurality of types of lock contenders.

The processor 302 is further configured to transition the lock contender to at least one of a context-switching mode and a low-power mode based on the identified type of lock contender and comparing the execution cost of each mode against a blocking threshold.

The memory 304 includes a non-transitory computer readable medium. The memory 304 includes a random-access memory (RAM), a read only memory (ROM), and/or another type of dynamic or static storage device (e.g., a flash memory, a magnetic memory, and/or an optical memory) that stores information and/or instructions for use by processor 302. The memory 304 comprises machine-readable instructions which are executable by the processor 302. These machine-readable instructions when executed by the processor 302 cause the processor 302 to perform one or more method steps of an embodiment described above.

The input component 306 may be configured to receive information, such as user input. For example, the input component 306 may include, but not be limited to, a touch screen display, a keyboard, a keypad, a mouse, a button, a switch, and/or a microphone. The output component 308 is configured to display information from the system 300 to the user or other systems, utilizing a variety of devices and technologies tailored to specific application needs. The output component 308 may include visual output devices such as display screens (LCD, LED, OLED), projectors, and heads-up displays (HUDs) for presenting graphical or textual information. Additionally, auditory output through speakers and headphones provides audio feedback and alerts, while haptic output devices, like vibration motors in smartphones or game controllers, offer tactile feedback. Functionally, the output component serves multiple roles, including displaying graphical user interface (GUI) elements for user interaction, delivering notifications and alerts through sound, visual indicators, or vibrations, and rendering complex data visualizations like charts and graphs for easier comprehension.

In an embodiment, the output component 308 may be configured to receive processed data from the processor 302, which determines the information to be communicated, and the output component 308 may access the memory 304 to retrieve and display stored information such as documents, media files, or application states. Furthermore, the output component 308 may be configured to meet the specific requirements of different applications, such as high-resolution visual output and immersive audio for gaming systems or clear and precise data visualization and alert mechanisms for industrial control systems. Through these varied output methods, the output component 308 ensures effective communication of information, enhancing both system 300 functionality and user experience.

In an embodiment, the shared resource 312 is a sharable memory which is accessible by multiple callers or processes (hereinafter referred to as simply callers) running on the processor 302. The shared memory is typically used in symmetric-multiprocessor (SMP) systems for coordinating access to “critical” code sections, i.e., code sections that can only be executed by one process at a time. Other suitable sharable resources may include logical devices, physical devices, and the like. It should be understood that the main memory or the memory 304 is capable of being formed from a combination of volatile memory (e.g., semiconductor memory) and non-volatile memory (e.g., disk drives), and that the shared memory 312 is capable of residing in a contiguous or integrated manner with the main memory 304 (e.g., on one or more memory circuit boards containing semiconductor memory).

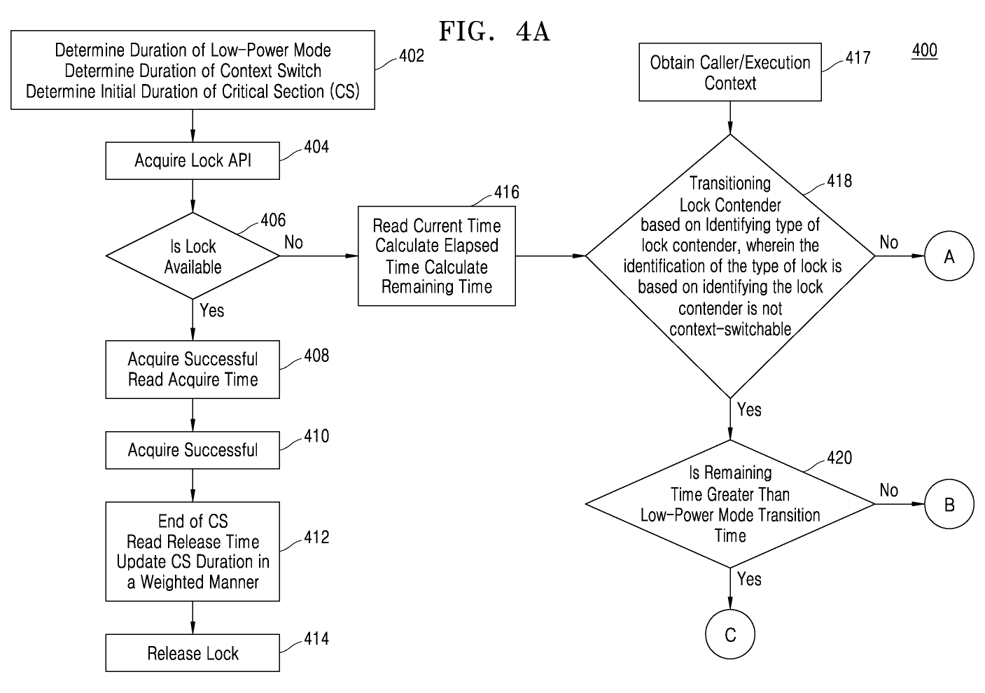

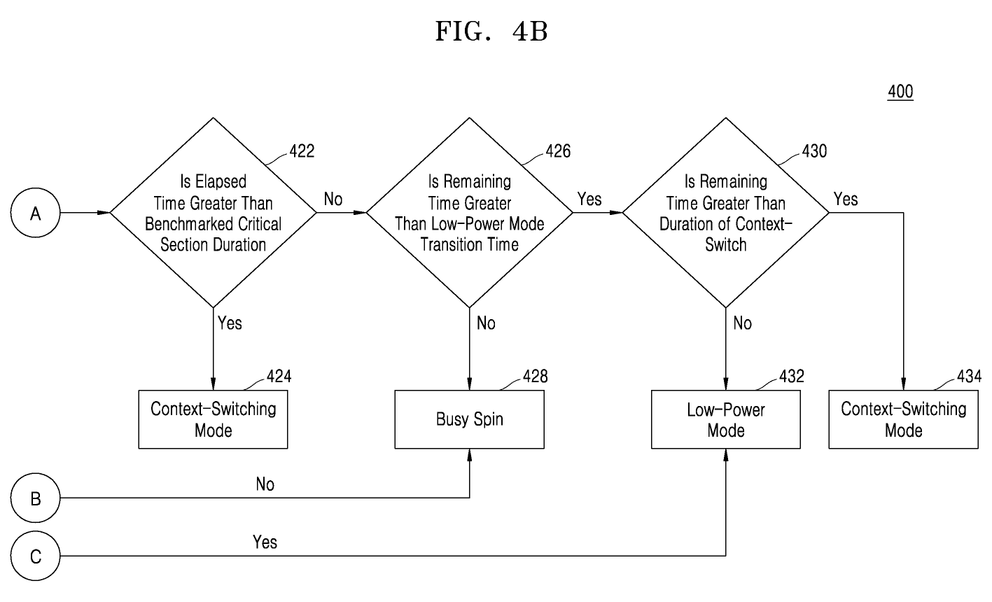

FIGS. 4A and 4B illustrate a method 400 for dynamically adaptive synchronization mechanism, according to an exemplary embodiment of the present disclosure.

In an embodiment, at step 402, the method 400 may include benchmarking at least one of a time required to context-switch between execution contexts, a time required to switch to the low-power mode, and a time required to complete one or more critical sections from every calling point. The calling point indicates a predefined code block where the critical section is invoked.

The benchmarking is a process of measuring and recording the time taken for key operations such as the context-switching between execution contexts, switching to the low- power mode when waiting for the lock, and completing critical sections from different calling points.

The context-switching involves the process of saving and restoring state of a caller or process to allow multiple processes to share a single CPU efficiently. Measuring the context-switching time helps in optimizing scheduling policies and improve system performance.

Similarly, measuring the time required for switching to a low-power mode is crucial for balancing power efficiency with performance, ensuring that resources are utilized optimally without unnecessary energy consumption.

Additionally, recording the time taken to execute critical sections from different calling points allows for better understanding and refinement of execution flows, ensuring minimal delays and efficient lock management. The critical section refers to a segment of a program where a shared resource, such as a data structure or hardware component, is accessed by multiple execution entities, such as threads, processes, or ISRs.

Upon benchmarking the at least one of the time required to context-switch between execution contexts, the time required to switch to the low-power mode, and the time required to complete one or more critical sections, at step 404, the method includes initiating an acquisition of a lock by a lock contender among one or more lock contenders based on contention. The acquisition of the lock indicates exclusive access to a shared resource.

The shared resource is a data structure, hardware component, or software entity that multiple execution entities such as threads, interrupt service routines (ISRs), signals, and bottom-half handlers attempt to access concurrently. Examples of the shared resource may include memory data structures, hardware components, database records, and the like.

The lock contender refers to an execution entity, such as a thread, process, interrupt service routine (ISR), signal handler, or tasklet, that competes to acquire a lock for exclusive access to a shared resource. In a multicore environment, multiple execution entities may attempt to access a critical section simultaneously, leading to lock contention.

For example, when a lock contender requests access to a locked resource, the lock contender waits until the lock is released by the current owner. Thus, depending on system policies and scheduling strategies, the lock contender may handle this waiting period using different approaches, such as busy-spinning, context-switching, or transitioning to a low-power mode.

In an embodiment, the one or more lock contenders include at least one of a thread, an interrupt-service routine (ISR), a signal, a bottom-half interrupt handler, and an idle caller, and any execution context where the context switching is not possible.

In an embodiment of the present disclosure, the thread is a lightweight execution unit within a process that operates independently but shares resources like memory and open files. Multiple threads can contend for the same lock when executing concurrent tasks. The ISR is a high-priority code segment executed in response to hardware or software interrupts. The signal is an asynchronous notification mechanism used in operating systems to alert a process or thread of an event. If the signal handler modifies shared resources, the signal may need to acquire a lock, leading to contention with other execution entities.

The bottom-half interrupt handler is a deferred execution mechanism for handling non-critical interrupt processing tasks. Examples may include softIRQs and tasklets, which execute at a lower priority than ISRs but still require lock access when updating shared data structures.

The idle thread is a special execution entity that runs when no other tasks are available for execution. The idle thread may become a lock contender if the idle thread participates in background maintenance tasks requiring exclusive access to the shared resources.

At step 406, the method 400 includes determining whether the lock is currently available. If the lock is available, step 408 is performed. If the lock is unavailable or busy, step 416 is performed. In an embodiment of the present disclosure, a lock is available when the lock is not currently held by any other caller, process, or execution unit, allowing a new contender to acquire it and gain exclusive access to the shared resource. In other words no other contender is actively using or holding the lock, and it is free for immediate acquisition.

In an embodiment. the lock is unavailable or busy indicates that the lock is currently held by a contender (e.g., a thread, an interrupt service routine (ISR), or a task), meaning that no other contender can acquire it until the current lock is released. When a lock is unavailable, other contenders must wait, retry, or transition to an alternate execution mode (such as context-switching or low-power mode) based on the system's scheduling policies.

At step 408, upon detecting that the lock is available, the method 400 includes successfully acquiring the lock by the contender. Further, the acquisition time is recorded and stored in the memory 304 of the system 300.

At step 410, the method 400 includes proceeding with the execution of the critical section. The is a segment of code in a multi-threaded or multi-process environment where the shared resource 312 accessed or modified.

At step 412, the method 400 includes recording or reading release time and updating the critical section duration in a weighted manner. In other words when the lock is released and updating the stored critical section duration for refinement of scheduling policies.

At step 414, the method 400 includes releasing the acquired lock, allowing other contenders to attempt lock acquisition.

At step 416, referring to step 406, wherein upon determination that the lock is currently unavailable or detecting that the lock is busy, the method 400 includes computing at least one of an elapsed time since lock acquiring the lock and a remaining time till lock is released. The lock busy indicate that the lock is acquired by at least one or more of lock contenders. The method 400 also computes the remaining time until the lock is freed as the difference between the computed critical section duration and the elapsed time. Further, the elapsed time indicates a difference between a current time and the current lock acquisition time.

At step 417, the method 400 includes obtaining caller context of the lock contender. The lock contender may belong to one of multiple caller contexts, such as a thread, an Interrupt Service Routine (ISR), a Signal, a Bottom-Half Interrupt Handler (such as softirqs and tasklets), an Idle Thread, or another caller context.

At step 418, the method 400 includes identifying a type of lock contender based on identifying whether the lock contender is not context-switchable. The type of lock contender corresponds to a predefined set of types. The context-switchable refers to a process, thread, or execution unit that may be pre-empted and transitioned to a different execution context by the operating system or scheduler. In other words when the lock is busy, the context-switchable lock contender may be suspended and replaced with another process or thread, allowing the CPU to perform other tasks instead of continuously waiting. Further, the predefined set of types may include a thread, the ISR, a signal handler, and the like.

In an embodiment, if the lock contender is an ISR, tasklet, bottom-half handler, signal handler, or another context where the context switching is not possible or impractical, step 422 is performed. If the identified lock contender is not the ISR, the tasklet, the bottom-half handler, signal handler, or another context where switching is possible, step 420 is performed.

At step 418, the method 400 may further include transitioning the lock contender to at least one of the context-switching mode, the busy-spinning mode, and a low-power mode based on the identified type of the lock contender. The transitioning is based on a plurality of factors comprising a lock contender's capability to transition to each of the modes, a current state of a lock owner indicated by elapsed time, a relative execution cost associated with each of the modes, and a predicted remaining time until the lock becomes available.

In one embodiment, while transitioning the lock contender to at least one of the context-switching mode, the busy-spinning mode, and the low-power mode, at step 420, if the computed remaining time is less than the low-power mode transition time, the method 400 may include transitioning the lock contender to the busy-spinning-mode.

At step 422, if the elapsed time is greater than the benchmarked critical section duration and the lock contender is context-switchable, the method 400 includes transitioning the contender to the context-switching mode at step 424.

At step 426, if the remaining time is lower than the time required to switch to the low-power mode, the method 400 includes transitioning the contender to the busy-spinning mode at step 428 to avoid unnecessary power state transitions.

At step 430, if the remaining time is not greater than a duration of the context-switch, the method 400 includes transitioning the contender to low-power mode at step 432 to conserve energy.

At step 434, if the remaining time is greater than both the low-power mode transition time and the context switch time, and the lock contender does not belong to a plurality of non-context-switchable contenders, the method 400 includes transitioning the contender to the context-switching mode.

In an exemplary scenario, consider a multi-threaded operating system (OS) managing multiple execution contexts, including threads, interrupt-service routines (ISRs), and background tasks. The operating system may include a shared resource, such as a data buffer, that requires synchronization using a locking mechanism.

At step 402, the OS may be configured to benchmark the time required to perform a context switch between execution contexts, the time required to transition into a low-power mode, and the time needed to complete a critical section of code.

For example, the OS may be configured to determine the duration of the context switch i.e., 5 microseconds, the duration to transition to the low-power mode may be 2 microseconds, and a duration of critical section may be 12 microseconds.

At step 404, a worker caller may be configured to initiate to acquire the lock on the shared resource 312 to write sensor data. The worker caller competes with other execution contexts, including an ISR handling a high-priority timer event and a background logging process.

At step 406, the OS may be configured to check if the lock is available. If the lock is available, at step 408, the worker caller acquires the lock, and the acquisition time is recorded. If the lock is unavailable or busy, step 416 is performed. The worker caller proceeds to step 410, executing its critical section, which involves writing new sensor data into the buffer.

At step 412, once the critical section is completed, the worker caller records the lock release time and updates the critical section duration data. At step 414, the worker caller releases the lock, allowing other contenders to proceed.

In another scenario, at step 416, if the worker caller detects that the lock is already held by another execution context, the worker caller may then compute the elapsed time since the lock was last acquired and estimates the remaining time until the lock will be released. In an exemplary scenario, if the elapsed time is 6 microseconds, and the critical section duration is 12 microseconds the OS may be configured to calculate the remaining time as 6 microseconds.

At step 417, the OS may be configured to identify the type of lock contender currently holding the lock. In an exemplary scenario, the current lock owner is an ISR executing a short but critical task. At step 418, the OS may be configured to determine whether the waiting lock contender (the worker caller) is context-switchable. At step 418, the OS may be configured to transition the lock contender to at least one of the context-switching mode, the busy-spinning mode, and a low-power mode based on the identified type of the lock contender.

At step 420, the OS compares the execution cost of different contention resolution modes. In an example, the execution cost of the context-switching mode is 4 microseconds, the execution cost of the busy-spinning mode is continuous CPU usage, and the low-power mode transition time is 12 microseconds.

At step 422, if the elapsed time exceeds a predefined threshold and the worker caller is context-switchable, the OS transitions it to context-switching mode at step 424, allowing other processes to execute.

At step 426, if the remaining time until lock release is very short (e.g., 2 microseconds, less than the low-power mode transition time), the OS keeps the worker caller in the busy-spinning mode at step 428 to minimize unnecessary transitions.

At step 430, if the remaining time is less than the duration of context switch (e.g., 15 microseconds), the OS may be configured to transition the worker caller into low-power mode at step 432 to conserve energy.

At step 434, if the remaining time is greater than both the context switch and low-power mode transition time, and if the worker caller is context-switchable, the OS may be configured to transition the worker caller to context-switching mode to allow more efficient CPU utilization.

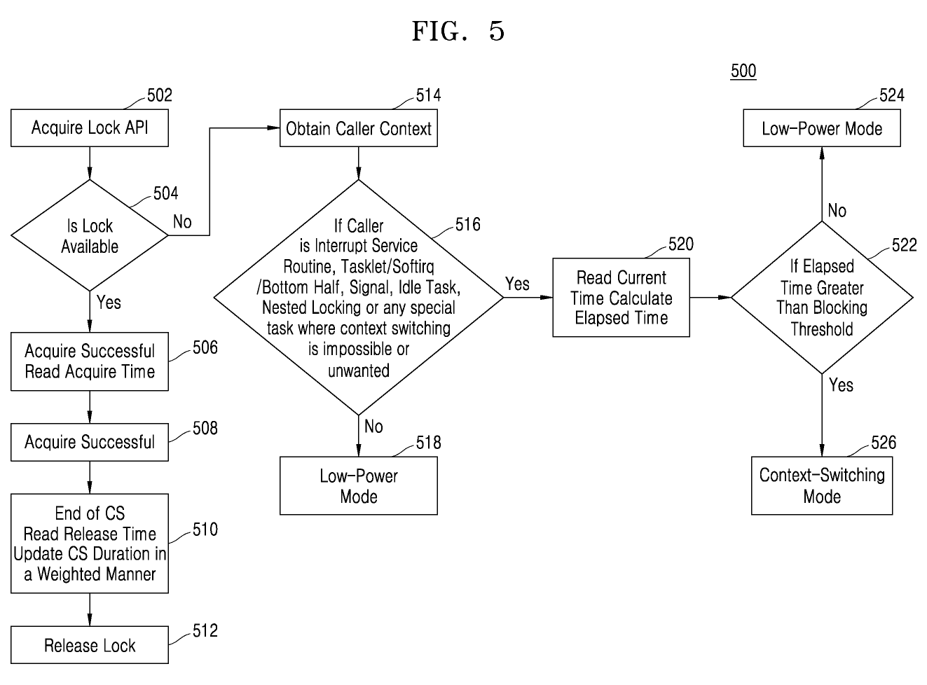

FIG. 5 illustrates a method 500 for dynamically adaptive synchronization mechanism, according to another embodiment of the present disclosure.

In an embodiment, at step 502, the method 500 includes initiating an acquisition of the lock by the lock contender using the lock acquire API. The lock acquisition request is made by the lock contender among the one or more lock contenders based on the contention for access to the shared resource 312.

At step 504, the method 500 includes determining whether the lock is currently available. If the lock is available, the process proceeds to step 506; otherwise, the lock contention is handled separately.

At step 506, upon detecting that the lock is available, the method 500 includes recording the lock acquisition time upon successfully acquiring the lock. At step 508, the method 500 includes acquiring the lock successfully, granting exclusive access to the shared resource.

At step 510, after completing execution of a critical section, the method 500 includes reading the lock release time and updating the critical section duration in a weighted manner for refinement of scheduling policies. At step 512, the method 500 includes releasing the lock, allowing other lock contenders to attempt acquisition.

In another scenario, if the lock is unavailable or the lock is busy, at step 504, the method 500 proceeds to step 514, where the caller context is obtained. The caller context includes information about the nature of the contender, such as whether it is a thread, an interrupt service routine (ISR), a signal handler, a tasklet, or an idle task.

At step 516, the method 500 includes compute the elapsed time and the remaining time based on current time the lock contender based on detecting the lock is busy upon identifying a type of the lock contender based on detecting the lock is busy. The type of lock contender is associated with a plurality of types of lock contenders.

At step 518, the method 500 may include transitioning the lock contender to at least one of the context-switching mode and the low-power mode based on the identified type of lock contender and comparing the execution cost of each mode against a blocking threshold. The blocking threshold is determined based on one or more configuration parameters of at least one of a current task and a dynamic value, wherein the dynamic value is determined based on information related to ongoing activities in computer operating environment.

In an embodiment, if the detected lock contender is not ISR, tasklet, bottom-half handler, signal handler, nested locking task, or any execution context where context switching is impractical or undesirable, at step 520, the method 500 includes reading the current time and computing the elapsed time since the lock was last acquired. The elapsed time is calculated as the difference between the current time and the previous lock acquisition time.

At step 522, the method 500 includes comparing the computed elapsed time against a blocking threshold. The blocking threshold is determined based on one or more configuration parameters of the current task or dynamically based on system conditions.

At step 524, if the elapsed time is less than the blocking threshold, the method 500 may include transitioning the lock contender to the low-power mode based on detecting a computed elapsed time is less than a predefined blocking threshold. The elapsed time is a difference between the current time and a previous lock acquisition time.

At step 526, the method 500 includes transitioning the lock contender to the context-switching mode based on detecting the computed elapsed time is greater than the blocking threshold. The elapsed time is a difference between the current time and the previous lock acquisition time.

In an exemplary scenario, consider a multicore embedded system managing a real-time task scheduler, multiple threads, including real-time tasks, interrupt service routines (ISRs), and background worker threads, compete for access to a shared memory buffer protected by a mutex lock.

For example, when a high-priority real-time thread (RT-Thread-1) requests the lock via the lock acquire API, the multicore embedded system may be configured to first check if the lock is available. If the lock is available, the multicore embedded system may be configured to grant the lock to RT-Thread-1, records the lock acquisition time, and allows RT-Thread-1 to execute its critical section.

Once the RT-Thread-1 completes its operation, the RT-Thread-1 may be configured to release the lock, updating the lock release time to refine scheduling policies. However, if the lock is already held by another thread, such as RT-Thread-2, lock contention handling begins.

To resolve contention, the multicore embedded system may be configured to identify the type of contender attempting to acquire the lock, classifying it as either non-context-switchable (e.g., ISR, tasklet, bottom-half handler, or nested locking task) or context-switchable (e.g., worker thread or background task).

In an exemplary embodiment, if the lock contender is non-context-switchable, the multicore embedded system may be configured to transition the lock contender to low-power mode until the lock becomes available, as context-switching is impractical in such cases.

In another exemplary embodiment, if the lock contender is context-switchable, the multicore embedded system may be configured to calculate the elapsed time since the last lock acquisition and compares the elapsed time with a blocking threshold. If the elapsed time is less than the blocking threshold, the lock contender is placed in low-power mode to conserve energy. If the elapsed time exceeds the blocking threshold, the multicore embedded system may be configured to initiate context-switching, allowing another process to execute instead of wasting CPU cycles on waiting.

The present invention provides various advantages:

The method 400 efficiently manages lock contention in a multicore environment by dynamically classifying lock contenders and determining optimal contention-handling strategies. The invention ensures that high-priority tasks gain timely access to shared resources, improving system responsiveness and throughput.

The method 400 optimizes power efficiency by transitioning non-context-switchable contenders to a low-power mode and dynamically determining whether context-switchable contenders should undergo context-switching or enter low-power mode based on a blocking threshold. Such an adaptive approach reduces unnecessary power consumption while maintaining system performance.

The present invention enhances scheduling efficiency by benchmarking lock acquisition and release times, allowing for data-driven refinement of scheduling policies. This ensures that future contention scenarios are handled more effectively, reducing contention overhead and improving real-time task execution.

The dynamic computation of elapsed time and blocking thresholds enables intelligent contention resolution, preventing unnecessary busy-waiting and CPU resource wastage.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. While the present disclosure has been described with reference to exemplary embodiments thereof, it will be apparent to those of ordinary skill in the art that various changes and modifications may be made thereto without departing from the spirit and scope of the invention as set forth in the following claims.

What is claimed is:

1. A method for dynamically adaptive synchronization mechanism, the method comprising:
initiating an acquisition of a lock by a lock contender among one or more lock contenders based on contention, wherein the acquiring of the lock indicates exclusive access to a shared resource;
computing at least one of an elapsed time since lock acquisition and a remaining time till lock is released in response to detecting that the lock is busy, wherein the busy lock indicates that the lock is acquired by at least one other lock contender from among the one or more lock contenders;
identifying a type of the lock contender based on identifying whether the lock contender is context-switchable, wherein the type of lock contender corresponds to one of a predefined set of types; and
transitioning the lock contender to a selected one of a context-switching mode, a busy-spinning mode, and a low-power mode, wherein the selection of the mode is based on a plurality of factors comprising a lock contender's capability to transition to each of the modes, a current state of a lock owner indicated by elapsed time, a relative execution cost associated with each of the modes, and a predicted remaining time until the lock becomes available.

2. The method as claimed in claim 1, further comprising:
before the initiating of the acquisition of the lock, benchmarking at least one of a time required to context-switch between execution contexts, a time required to switch to the low-power mode, and a time required to complete one or more critical sections from every calling point,
wherein the calling point indicates a predefined code block where the critical section is invoked.

3. The method as claimed in claim 2, wherein the remaining time indicates a difference between a time required to complete one or more critical sections from a predefined calling point and the elapsed time, and
wherein each of the benchmarked critical section and the predefined calling point indicates a calling point where the lock acquisition has occurred.

4. The method as claimed in claim 1, wherein the one or more lock contenders include at least one of a thread, an interrupt-service routine (ISR), a signal, a bottom-half interrupt handler, and an idle thread.

5. The method as claimed in claim 1, wherein the elapsed time indicates a difference between a current time and a previous lock acquisition time.

6. The method as claimed in claim 1, wherein the transitioning of the lock contender to at least one of the context-switching mode, the busy-spinning mode, and the low-power mode includes:
comparing an execution cost of each mode with the remaining time, and
wherein the execution cost indicates a total resources consumed while running a process.

7. The method as claimed in claim 1, wherein the transitioning of the lock contender to the context-switching mode is performed based on identifying that the elapsed time is greater than a time required to complete a critical section which would indicate abnormal behavior of the owner of the lock and the identified lock contender does not belong to a plurality of non-context-switchable lock contenders.

8. The method as claimed in claim 1, wherein the transitioning of the lock contender to the busy-spinning mode is performed based on identifying the remaining time is less than a time required to switch to the low-power mode.

9. The method as claimed in claim 1, wherein the transitioning of the lock contender to the low-power mode is performed when the identified lock contender is a context-switchable lock contender and the remaining time till lock is freed is greater than a time required to switch to the low-power mode but less than the time to context switch.

10. The method as claimed in claim 1, wherein the transitioning of the lock contender to the low-power mode is performed when the identified lock contender is a non-context-switchable lock contender and the remaining time till lock is freed is greater than time required to switch to the low-power mode.

11. The method as claimed in claim 1, wherein the transitioning of the lock contender to the context-switching mode is performed when the remaining time is greater than a time required to switch to the low-power mode and is greater than a context switch time, and
wherein the identified lock contender does not belong to a plurality of non-context-switchable lock contenders.

12. A method for dynamically adaptive synchronization mechanism, the method comprising:
initiating an acquisition of a lock by a lock contender among one or more lock contenders based on contention, wherein the acquiring of the lock indicates exclusive access to a shared resource;
identifying a type of the lock contender based on detecting the lock is busy, wherein the type of lock contender is associated with a plurality of types of lock contenders; and
transitioning the lock contender to at least one of a context-switching mode and a low-power mode based on the identified type of lock contender and comparing an execution cost of each mode against a blocking threshold.

13. The method as claimed in claim 12, wherein the blocking threshold is determined based on one or more configuration parameters of at least one of a current task and a dynamic value, wherein the dynamic value is determined based on information related to ongoing activities in computer operating environment.

14. The method as claimed in claim 12, wherein the transitioning of the lock contender to the low-power mode is performed based on detecting the identified lock contender belongs to a plurality of non-context-switchable lock contenders.

15. The method as claimed in claim 12, wherein, when the identified lock contender is a context-switchable lock contender, the transitioning of the lock contender to the low-power mode is performed based on detecting a computed elapsed time is less than a predefined blocking threshold, and
wherein the elapsed time is a difference between a current time and a previous lock acquisition time.

16. The method as claimed in claim 12, wherein the transitioning of the lock contender to the context-switching mode is preformed based on detecting a computed elapsed time is greater than a predefined blocking threshold, and
wherein the elapsed time is a difference between a current time and a previous lock acquisition time.

17. A system for dynamically adaptive synchronization mechanism, the system comprising:
a memory; and
a processor in communication with the memory, the processor configured to:
initiate an acquisition of a lock by a lock contender among one or more lock contenders based on contention, wherein the acquiring of the lock indicates exclusive access to a shared resource,
compute at least one of an elapsed time since lock acquisition and a remaining time till lock is released in response to detecting that the lock is busy, wherein the busy lock indicates that the lock is acquired by at least one other lock contender from among the one or more lock contenders,
identify a type of the lock contender based on identifying whether the lock contender is context-switchable, wherein the type of lock contender corresponds to one of a predefined set of types, and
transition the lock contender to a selected one of a context-switching mode, a busy-spinning mode, and a low-power mode,
wherein the selection of the mode is based on a plurality of factors comprising a lock contender's capability to transition to each of the modes, a current state of a lock owner indicated by elapsed time, a relative execution cost associated with each of the modes, and a predicted remaining time until the lock becomes available.

18. The system as claimed in claim 17, wherein the processor is configured to:
before the initiating of the acquisition of the lock, benchmark at least one of a time required to context-switch between execution contexts, a time required to switch to the low-power mode, and a time required to complete one or more critical sections from every calling point, and
wherein the calling point indicates a predefined code block where the critical section is invoked.

19. The system as claimed in claim 17, wherein the one or more lock contenders includes at least one of a thread, an interrupt-service routine (ISR), a signal, a bottom-half-interrupt handler, and an idle thread.

20. The system as claimed in claim 17, wherein the elapsed time indicates a difference between a current time and a previous lock acquisition time.
